(19) United States
(12) Patent Application Publication
(10) Pub. No.: US 2011/0298726 A1
(43) Pub. Date: Dec. 8, 2011

(54) DISPLAY DEVICE FOR SMART PHONE

(75) Inventors: Chien-chung Wu, Wugu City (TW); Bo-ren Wang, Wugu City (TW)

(73) Assignee: HANNSTAR DISPLAY CORPORATION, WUGU (TW)

(21) Appl. No.: 12/876,215

(22) Filed: Sep. 6, 2010

(30) Foreign Application Priority Data
Jun. 3, 2010 (TW) 099117942

(51) Int. Cl. G06F 3/041; G06F 1/16; H04R 1/02; G09G 5/00; H04N 5/225

(52) U.S. Cl. 345/173; 345/211; 348/374; 381/388; 361/679.21

(57) ABSTRACT

A display device for displaying multiple images includes a first container for adapting a first display unit, a second container for adapting a second display unit, and a computing module for adjusting a first resolution of a first image generated by the first display unit into a second resolution of a second image generated by the second display unit. The second image is larger than that of the first image. Also, each display unit further includes a touch panel thereon so that the user can control the first display unit by contacting one of the touch panels.

### BACKGROUND OF THE INVENTION

1. Field of the Invention

The present invention is related to a display device for a smart phone, and more particularly, to a display device that can duplicate and display images of the smart phone on another display unit.

2. Description of Prior Art

Nowadays the public are becoming more dependent on electronic products along with the development of technology. Electronic products, such as mobile phones, handheld PCs, personal digital assistances (PDAs), and smart phones, exist everywhere in our daily life. In order to become more convenient, more compact, and more user-friendly, many electronic products have adopted a touch panel as an input device, instead of using traditional input devices such as a keyboard, a mouse, and so on. Touch panels can be assembled onto a wide variety of flat panel displays so that the flat panel displays have a function of displaying pictures as well as inputting operational information.

Smart phones offer more and more powerful functions; however, users cannot accordingly obtain a better operational and using environment when using multiple functions at the same time, because the size of the display screens of smart phones is too small. For instance, a user may touch undesired icons when some icons are simultaneously shown on the narrow display screen of a smart phone. Also, the user may have difficulty viewing the pictures shown by the small display screen. The problems mentioned above need to be solved by businesses.

### SUMMARY OF THE INVENTION

Therefore, an object of the present invention is to provide a display device which comprises a main body, a first container, a second container, and a computing module. The first container is positioned on the main body and adapts a first display unit. The first display unit produces a first image. The second container is positioned on the main body and adapts a second display unit. The second display unit produces a second image. The computing module, is placed in the main body, adjusts the first resolution of the first image generated by the first display unit into the second resolution of the second image generated by the second display unit.

According to the present invention, the first container further comprises a groove on one side for dismantling the first display unit from the first container by imposing an external force.

According to the present invention, the first display unit comprises a first touch panel for generating a first induction signal to control the operation of the first display unit when being touch sensed. The second display unit comprises a second touch panel for generating a second induction signal to control the operation of the first display unit when being touch sensed. The display device further comprises a transmitting module. The transmitting module, connecting between the first touch panel and the second touch panel, transmits the second induction signal to the first display unit.

According to the present invention, the display device further comprises a display control interface (DCI). The DCI determines whether to display the first and the second images simultaneously when being activated.

According to the present invention, the first display unit comprises a power module for providing the first display unit with the required amount of electricity. The display device further comprises a power terminal, which is positioned on the main body and is placed in first container with the first display unit. The power terminal provides both of the first display unit and the display device with the required amount of electricity.

According to the present invention, the display device further comprises a camera, which is placed in the main body. The camera shoots pictures and shows the pictures on the first display unit or the second display unit.

According to the present invention, the display device further comprises a speaker, which is placed in the main body. The speaker plays the sound generated by the first display unit.

The disclosed inventions will be described with references to the accompanying drawings, which show important example embodiments of the inventions and are incorporated in the specification hereof by related references.

### BRIEF DESCRIPTION OF THE DRAWINGS

FIG. 1 is a front view of a display device according to a preferred embodiment of the present invention.

FIG. 2 is a back view of a display device according to a preferred embodiment of the present invention.

FIG. 3 is a functional block diagram illustrating the display device and first display unit of the present invention.

### DETAILED DESCRIPTION OF THE PREFERRED EMBODIMENTS

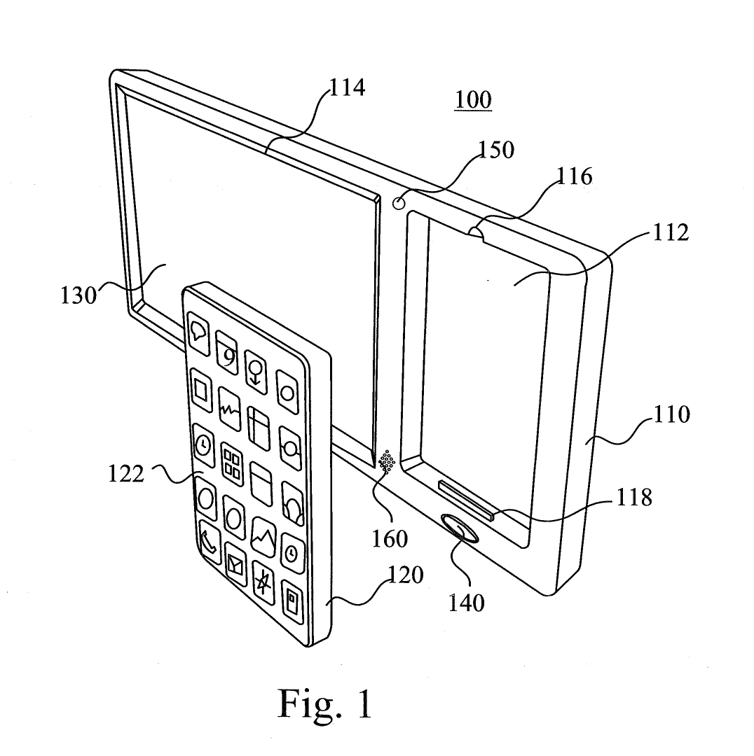

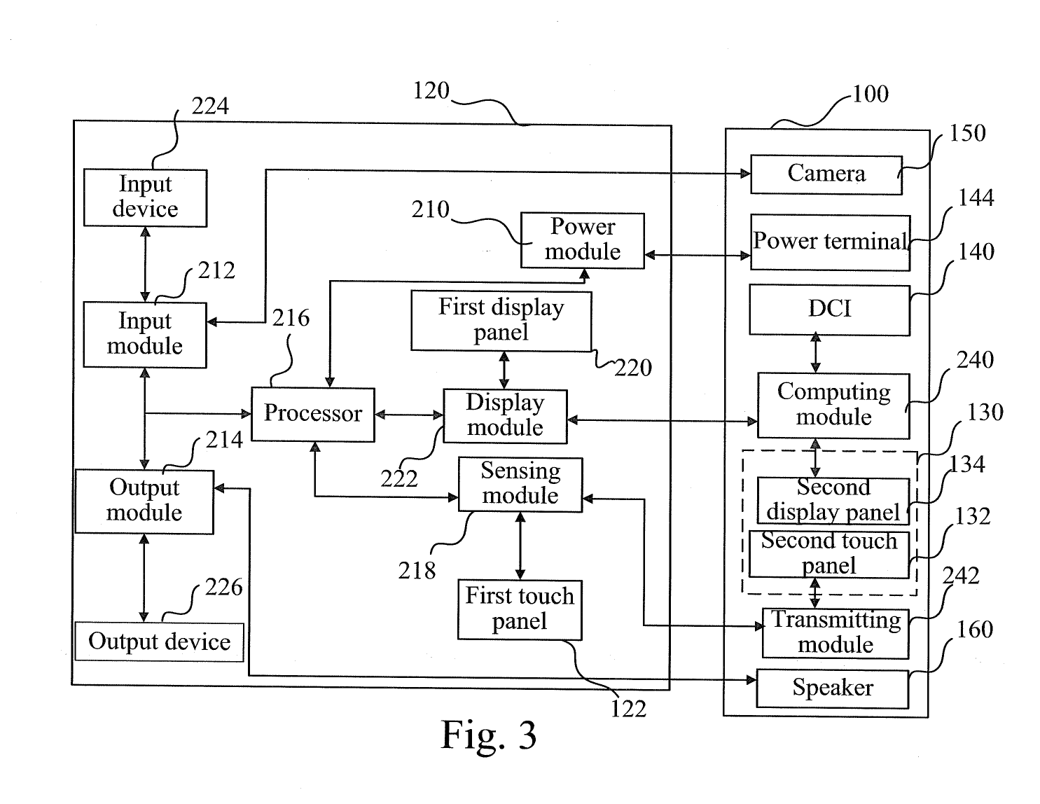

Referring to FIG. 1, FIG. 1 is a front view of a display device 100 according to a preferred embodiment of the present invention. As shown in FIG. 1, the display device 100 can be inserted with a first display unit 120. The display device 100 comprises a main body 110, a first container 112, a second container 114, a second display unit 130, a display control interface (DCI) 140, a camera 150, and a speaker 160. The first container 112 and the second container 114 are both positioned on the main body 110. The first container 112 is disposed with a groove 116 on one side and a connecting terminal 118 on the other side. The first container 112 adapts a first display unit 120, which can be a handheld communications device, a handheld computing device, a smart phone, or a personal digital assistant (PDA). The first display unit 120 generates a first image comprising a plurality of icons. On the first display unit 120, a first touch panel 122 is positioned. When the first touch panel 122 is touch sensed, it generates a first induction signal to control the operation of the first display unit 120. The first display unit 120 can be placed in the first container 112. Whenever the first display unit 120 is not utilized, a user can dismantle it from the first container 112 by pressing the groove 116 with his/her finger. The second display unit 130 is fixed in the second container 114 for generating a second image. The DCI 140 is coupled to the first display unit 120 and the second display unit 130 for sensing and receiving a user's input. When the DCI 140 is activated by the user, it can determine whether to display the first image of the first display unit 120 and the second image of the second display unit 130. The second image of the second display unit 130 is a large (or small) version of the first image of the first display unit 120. The second display unit 130 comprises a second touch panel 132 (shown in FIG. 3). The purpose of this design will be discussed later. The camera 150 of the display device 100 is placed in the main body 110 for shooting pictures and displaying the pictures on either the first display unit 120 or the second display unit 130. The speaker 160 is placed in the main body 110 and plays the sound generated by the first display unit 120. The display device 100 in the present embodiment is a bar-type electronic device. The present embodiment, however, is merely an example and not limited by the scope of the present invention.

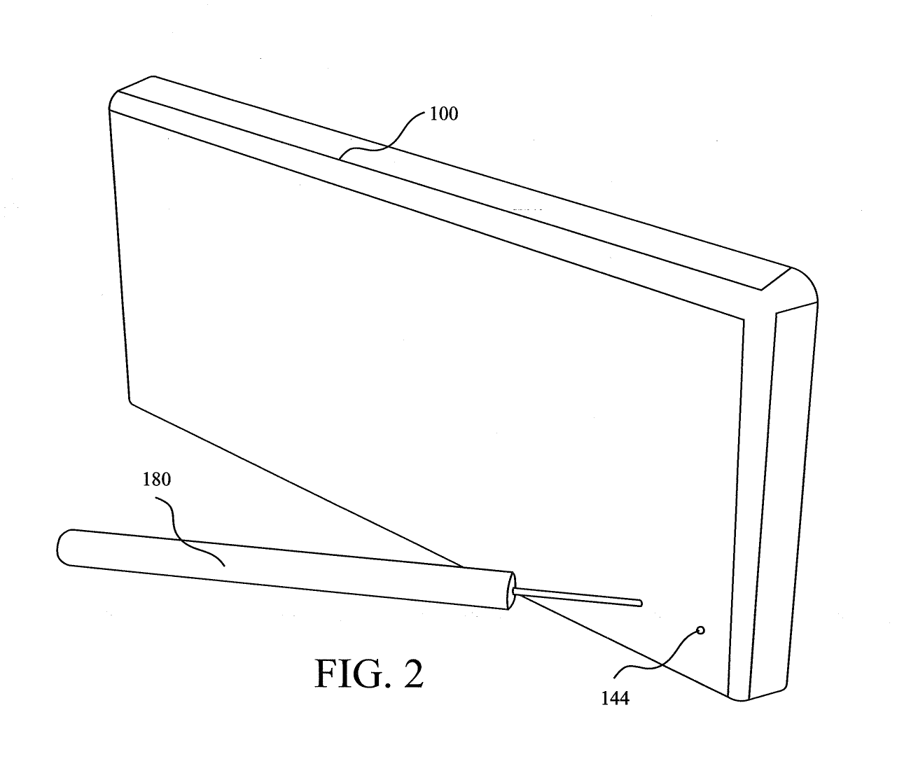

Referring to FIG. 2, FIG. 2 is a back construction diagram of the display device 100 of the present invention. The display device 100 further comprises a power terminal 144. After the power terminal 144 is inserted with the tip of a stand 180, the display device 100 will start to operate. After the first display unit 120 is placed in the first container 112 and the connecting terminal 118 connects the power interface of the first display unit 120, the first display unit 120 can also operate according to the amount of electricity used by the display device 100, which can save the battery power of the display unit 120. In addition, the stand 180, inserted into the power terminal 144, can keep the display device 100 from falling down when the display device 100 is put in an upright position. The stand 180 can be substituted for a user's finger. After the user contacts the first touch panel 122 or the second touch panel 132 with his/her finger, an induction signal will be generated to control the operation of the first display unit 120.

Referring to FIG. 3, FIG. 3 is a functional block diagram of the display device 100 and the first display unit 120 of the present invention. The display device 100 further comprises a computing module 240, and the first display unit 120 further comprises a power module 210, an input module 212, an output module 214, a processor 216, a sensing module 218, a first display panel 220, a display module 222, an input device 224, and an output device 226. The processor 216 performs the entire operation of the first display unit 120. The amount of electricity which the first display unit 120 requires to perform the operation can be obtained either from the power module 210 alone or from the power terminal 144 of the display device 100. The input device 224 comprises an analog signal received by a microphone, a camera, or other devices. Through the input module 212, a digital signal corresponding to the analog signal is generated. After the digital signal is processed by the processor 216, it will be transmitted to the display module 222 to generate an image signal or to the output module 214 to generate an audio signal. Finally, the signal is transformed to an image shown by the first display panel 220 or to a sound output by the speaker 160 of the output module 214. The sensing module 218 generates an induction signal according to a position where the first touch panel 122 is contacted and transmits the induction signal to the processor 216 for further processing.

The display device 100 comprises a computing module 240 and a transmitting module 242. When the DCI 140 is triggered to determine simultaneously displaying images by the first display unit 120 and the second display unit 130, the computing module 240 within the main body 110 adjusts the first image with a first resolution produced by the display module 222 into a second resolution of the second image shown on the second display unit 130. The computing module 240 is placed in the main body 110 for adjusting the resolution of an image generated by the display module 222 of the first display unit 120 into the resolution of an image shown by the second display unit 130. In this way, the second display panel 134 can enlarge (or shrink) the image generated by the first display unit 120 shown on the first display panel 220. Moreover, the transmitting module 242 is electrically coupled to the second touch panel 132 and the sensing module 218 of the first display unit 120. After the user see the image displayed by the second display panel 134 (substantially this image is the large or small version of an image shown by the first display panel 220), he/she can contact the second touch panel 132 to generate an induction current. Afterwards, the induction current is transmitted to the sensing module 218 through the transmitting module 242, and then the sensing module 218 generates an induction signal to determine where the second touch panel 132 is contacted according to the induction current. Because the image contents shown on the second display panel 134 are as the same as the ones exhibited on the first display panel 220, the processor 216 can immediately know which icon or command is chosen by the user from the first display panel 220 synchronously according to the induction signal generated from the contacted position of the second touch panel 132.

Compared with the prior art, the display device of the present invention has two containers. The first container adapts a first display unit such as a smart phone or the like, and the second container adapts a second display unit, including a touch panel. The two containers communicate through a transmitting module. The display area of the touch panel inside the second container is larger than that of the touch panel inside the first container, so images generated by the smart phone can be enlarged. In this way, problems that users may touch an undesired icon because the size of the display screen of a smart phone at present is too small, or that users cannot watch films easily because the screen is too small, can be solved. Moreover, the two touch panels are controlled by a transmitting module in between. The user can contact a desired position on the touch panel of the second container with larger area, and the contacted position is simultaneously shown on the touch panel of the first container. Otherwise, the user can contact a desired position on the touch panel of the first container, and the contacted position simultaneously appears on the display screen of the second container. In addition, the smart phone, positioned on the first container, can be freely removed or replaced. The user can carry the display device of the present invention to replace his/her broken smart phone or to install another user's smart phone in the first container anytime. The display device of the present invention provides extreme portability and convenience.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A display device comprising:
a main body;
a first container positioned on the main body, for adapting a first display unit for generating a first image;
a second container positioned on the main body, for adapting a second display unit for generating a second image; and
a computing module placed in the main body, for adjusting a first resolution of the first image generated by the first display unit into a second resolution of the second image generated by the second display unit.

2. The display device of claim 1 wherein the first display unit is dismantled from the first container.

3. The display device of claim 2 wherein the first container further comprises a groove on one side for dismantling the first display unit from the first container by imposing an external force.

4. The display device of claim 1 wherein the first display unit comprises a first touch panel for generating a first induction signal to control the operation of the first display unit when the first touch panel is touched.

5. The display device of claim 4 wherein the second display unit comprises a second touch panel for generating a second induction signal to control the operation of the first display unit when the second touch panel is touched.

6. The display device of claim 5 wherein the display device further comprises a transmitting module, electrically connecting between the first touch panel and the second touch panel, for transmitting the second induction signal to the first display unit.

7. The display device of claim 1 wherein the display device further comprises a display control interface for determining whether to display the first image and the second image simultaneously when the display device is activated.

8. The display device of claim 1 wherein the first display unit comprises a power module for supplying the first display unit with electricity.

9. The display device of claim 8 wherein the display device further comprises a power terminal, positioned on the main body, for supplying the first display unit with electricity when the first display unit is placed in the first container.

10. The display device of claim 1 wherein the display device further comprises a camera, placed in the main body, for shooting pictures and displaying the pictures on the first display unit or the second display unit.

11. The display device of claim 1 wherein the display device further comprises a speaker, placed in the main body, for playing sound generated by the first display unit.
